(19) United States
(12) Patent Application Publication
(10) Pub. No.: US 2009/0218318 A1
(43) Pub. Date: Sep. 3, 2009

(54) VACUUM SWITCHING CHAMBER FOR MEDIUM-VOLTAGE SWITCHGEAR ASSEMBLIES

(75) Inventor: Dietmar GENTSCH, Ratingen (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/394,493

(22) Filed: Feb. 27, 2009

Related U.S. Application Data
(63) Continuation of application No. PCT/EP2007/007580, filed on Aug. 30, 2007.

(30) Foreign Application Priority Data
Sep. 1, 2006 (DE) 10 2006 041 149.8

(51) Int. Cl. H01H 33/662

(52) U.S. Cl. 218/134

(57) ABSTRACT

Vacuum switching chamber is disclosed for a medium-voltage switchgear assembly having one or more ceramic cylinder tube sections which are closed both on the fixed-contact side and on the switching-contact side by metallic covers. In order in the process to achieve a situation in which a vacuum switching chamber is further improved in terms of its resistance to external pressure the disclosure proposes providing at least one of the covers, on the inside and/or outside, with an inlay which increases the resulting wall thickness, an outer cover or outer ring, which inlay, outer cover or outer ring rests at least partially cohesively in the cover or on a cover on the outside.

### RELATED APPLICATIONS

This application claims priority under 35 U.S.C. §119 to German Application No. DE 10 2006 041 149.8 filed in Germany on Sep. 1, 2006, and as a continuation application under 35 U.S.C. §120 to PCT/EP2007/007580 filed as an International Application on Aug. 30, 2007 designating the U.S., the entire contents of which are hereby incorporated by reference in their entireties.

### TECHNICAL FIELD

The disclosure relates to a vacuum switching chamber for medium-voltage switchgear assemblies having one or more ceramic cylinder tube sections which are closed both on the fixed-contact side and on the switching-contact side by metallic covers.

### BACKGROUND INFORMATION

Known vacuum switching chambers are to an increasing extent cast round with casting resin in a form in accordance with the pressure gelation process. In this process, pressures of up to 10 bar arise which can be withstood by a standard VC without any alteration in terms of its construction. It is thus possible for the known pole parts to be produced from casting resin, silicone or polyurethane casings.

The use of—pressure-resistant—vacuum switching chambers is disclosed in the patent literature for a pressure of up to 20 bar, in particular for using these vacuum switching chambers under an insulating gas (air or SF₆). For this purpose, covers with a reinforced wall thickness are soldered onto the ceramic insulator of a vacuum switching chamber from the outside, but with a milled-out portion, i.e. a reduction in the wall thickness, of the cover collar in the transition region of the ceramic/metal joint for the purpose of reducing the contraction strain which occurs after soldering. Furthermore, a multilayer metal bellows can be/is used so that the entire vacuum switching chamber can be operated at the abovementioned pressure.

One example of this is known from DE 10007907. Herein, a vacuum switching chamber is equipped with pressure-reinforced covers and with a multilayer metal bellows for the use of the vacuum switching chambers at ambient pressures of up to 20 bar.

A further option is the use of ceramic insulators, which reach up to the feed lines of a vacuum switching chamber. It is thereby likewise possible to achieve an increase in the resistance to pressure. This is known from EP0660354 B1.

When pole parts are produced in accordance with one of the current processes, it is possible for a standard vacuum switching chamber to be used during casting, for example with a casting resin. When, for example, a plastic injection moulding process is selected as the casting process for producing pole parts in a minutes cycle, considerably higher pressures result during injection moulding. These pressures are at values of greater than 50 bar in the case of injection moulding of thermoplastics and may reach up to over 800 bar. However, the vacuum switching chambers need to be able to withstand the high pressures only in subregions during injection moulding, these subregions including the cover arranged on the fixed-contact side, the ceramic insulator (this is generally sufficiently pressure-resistant) and possibly a subregion of the cover on the switching-contact side. The metal bellows does not need to be pressure-resistant. If pressures in the abovementioned range are applied, reinforcement is required in the region of the ceramic/metal joint in which the wall thickness is in each case in the range of between 0.4 and 2 mm. Otherwise the vacuum switching chamber would not be able to withstand the high injection pressure in this region.

### SUMMARY

Exemplary embodiments disclosed herein can improve a vacuum switching chamber as regards its resistance to external pressure.

A vacuum switching chamber for a medium-voltage switchgear assembly is disclosed having one or more ceramic cylinder tube sections which are closed both on the fixed-contact side and on the switching-contact side by metallic covers, wherein at least one of the covers, arranged on the inside and/or outside, is provided with an inlay, which increases the resulting wall thickness, or overlay, which inlay or overlay rests at least partially cohesively in the cover or on the outside.

In another aspect, a method of arranging a vacuum switching chamber is disclosed for a medium-voltage switchgear assembly having one or more ceramic cylinder tube sections with a fixed-contact side and a switching-contact side. Such a method comprises closing the ceramic cylinder tube sections on the fixed-contact side and on the switching-contact side by metallic covers; providing at least one of the covers with an inlay which increases the resulting wall thickness; and resting an outer cover, an outer ring or the inlay at least partially cohesively in the cover or on a cover on the outside.

### BRIEF DESCRIPTION OF THE DRAWINGS

The disclosure will be explained in more detail below and illustrated in the drawing, in which:

FIG. 1 shows an exemplary vacuum switching chamber having ceramic cylinder tube sections and metallic covers;

FIG. 2 shows an exemplary vacuum switching chamber having a reinforcement within the chamber cover;

FIG. 3 shows an exemplary vacuum switching chamber having a ceramic end region; and

FIG. 4 shows an exemplary vacuum switching chamber having ceramic cylinder tube sections, soldered at the front to metallic covers.

### DETAILED DESCRIPTION

An exemplary embodiment of the disclosure provides at least one of the covers, on the inside and/or outside, with an inlay which increases the resulting wall thickness and rests at least partially cohesively in the cover, or a ring or caps rest on the outside. This inlay or outer overlay makes it possible to achieve a resistance to pressures of several 100 bar.

In another exemplary embodiment, the inlay or outer overlay is dimensioned and introduced or positioned such that it leaves a small gap from the bearing rim of the ceramic such that an integral collar formation of a central screen can be accommodated therebetween in the inner contact region during fitting.

In another exemplary embodiment, the inlays or overlays reach up to the inner front face of the covers. They are supported there and do not pass through the overlay on the rim of the ceramic body to a stiffened-out portion of the cover, but the outer forces of pressure are deflected here onto the ceramic and supported on it.

The same naturally also applies to the first-mentioned exemplary embodiment, in which only the collar of the central screen is placed therebetween in the gap. The described deflection of forces is also not negatively influenced by this.

It is therefore now possible for the vacuum switching chamber to also be capable of transmitting forces in the longitudinal direction.

In another exemplary embodiment, the inlay together with the cover in total approximately corresponds to the wall thickness of the ceramic. Field-disrupting, protruding edges are therefore avoided.

In yet another exemplary embodiment, the inlays are configured such that they remain restricted to regions with a reduced wall thickness only in the region of the ceramic/metal joint.

Both cover sides of the vacuum switching chamber can be provided with in each case one inlay.

As an alternative exemplary embodiment. only one cover side can be provided with an inlay, while the other side is provided with a bowl-like shaped-out portion of the ceramic body which replaces the cover.

Overall, this disclosure results in a suitable structural reinforcement of the vacuum switching chamber in order to overcome the disadvantages and technical problems described at the outset.

The reinforcements can be introduced in the inner region, to be precise such that there is an introduction of force into the ceramic body. Positioning a reinforcement from the outside does not result in the corresponding reinforcement and introduction of force.

In addition, using the inlays according to the disclosure provides modularity in terms of fitting, i.e. the inlays can be introduced during fitting if they are required and can be omitted if they are not required. That is to say the vacuum chamber parts can be used uniformly and extended by this function or property or not. It is not necessary to make any changes to the basic elements of the vacuum chamber.

This now means that the resistance to external pressure can be markedly increased using pressure-resistant components, with the result that the VC can be used in a gas space at high pressure (for example in the SF₆ insulating gas). Furthermore, it is possible for a plastic to be injected around the vacuum switching chambers at a high pressure in accordance with a known injection-moulding process (pole part or pole part block production (3-phase)) and for the external dielectric strength of the unit to be increased thereby.

According to the one aspect of the disclosure, pressure reinforcement can be achieved in this region by an inlay which is as thick as the wall being inserted into the cover at least in this region. This inlay can remain restricted to this region or reaches up to the inner surface in order to reinforce the entire cover, i.e. fills the inner surface partially or else completely for reinforcing purposes.

If the vacuum switching chamber has a high pressure applied to it from the outside, in particular the thin-walled cover region bears against the inlay and therefore reliably produces the resistance to pressure of the entire vacuum switching chamber.

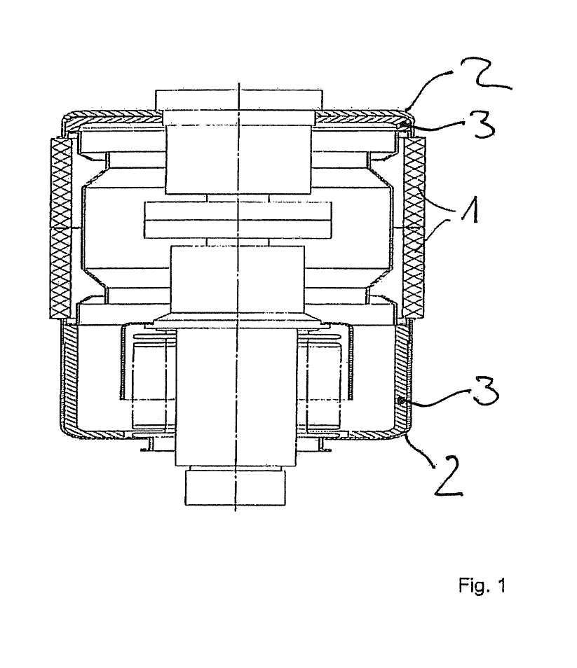

FIG. 1 shows an exemplary vacuum switching chamber, equipped with ceramic cylinder tube 1 sections, which are soldered at the front to metallic covers 2, for the purpose of producing a vacuum switching chamber. Inlays 3 which are as thick as the wall are inserted into the metallic covers in order to reinforce them against an external pressure. If an inlay as shown in FIG. 1 is selected, it comprises an inlay within the cover on the fixed-contact and on the switching-contact side. In addition to the pressure reinforcement of the covers, it is also possible for the rigidity of the vacuum switching chamber to be increased axially. The force of pressure (on the fixed-contact side) occurring during injection moulding can therefore be transmitted in the longitudinal direction beyond the ceramic insulators to the switching-contact side and its pressure-reinforcing inlay. This force is then absorbed by the core die of the injection mould.

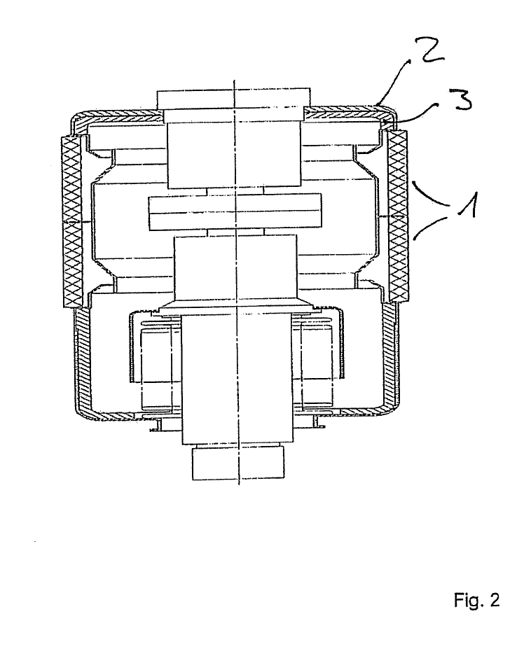

FIG. 2 shows an exemplary vacuum switching chamber with a reinforcement within the chamber cover which reaches up to the front faces of the ceramic insulators and transmits an axial force directly to the ceramic.

As shown in FIG. 2, the inlay can be arranged within the or else both vacuum switching chamber covers directly on the ceramic front face with a small gap after production or else above a component shown in FIG. 1.

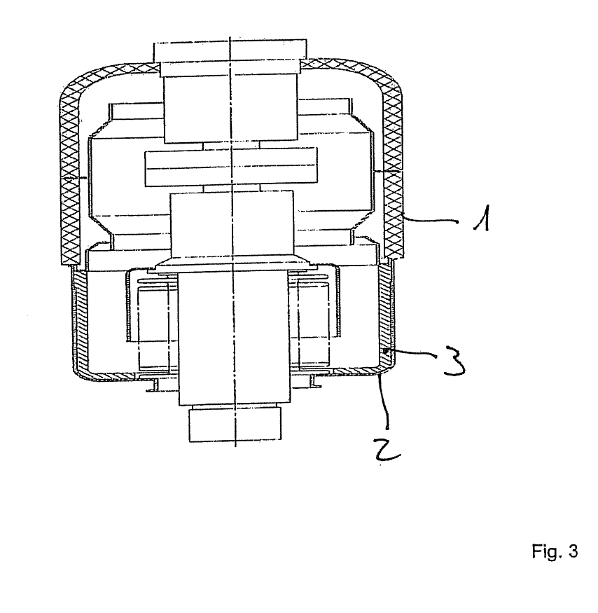

FIG. 3 shows an exemplary pressure-resistant vacuum switching chamber owing to the use of a ceramic insulator, which insulator reaches up to the feed lines of the VC, a bowl-shaped ceramic. A further possibility for producing a pressure-resistant vacuum switching chamber is the use of a ceramic which reaches up to the feed lines of the vacuum switching chamber (see EP 0660354 B1), for example a bowl-shaped ceramic as shown in FIG. 3. That is to say that, in this case, a metallic cover becomes superfluous at least on one side by the chamber ceramic having a distal end in the form of a bowl at least on the fixed-contact side. That is to say a cover is no longer provided at all on this side, but the ceramic is shaped out there in a corresponding manner. This also means that it is possible for the required resistance to pressure to be achieved directly. The other side, on the other hand, then contains the cover reinforced by the inlay according to the disclosure.

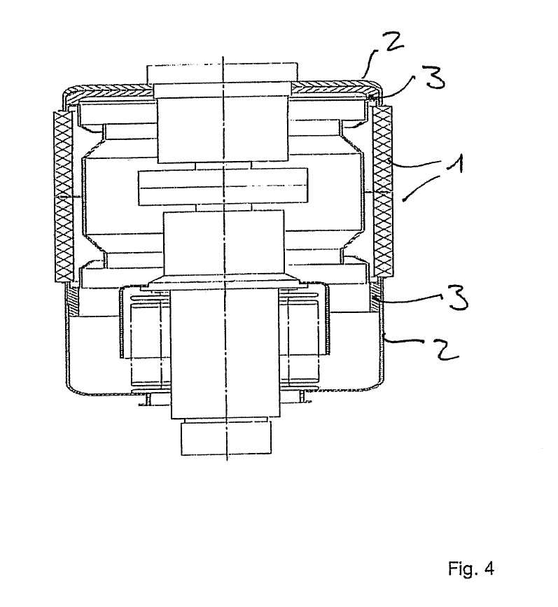

FIG. 4 shows exemplary vacuum switching chambers (VCs) equipped with ceramic cylinder tube sections, which are soldered at the front to metallic covers, for the purpose of producing a VC. Inlays which are as thick as the wall are inserted into the metallic covers for the purpose of reinforcing them against an external pressure. A further possibility is the use of a reinforcing ring (in one section) on the switching-contact side.

Furthermore, a combination as shown in FIG. 4 is used to increase the resistance to pressure. For example, a vacuum switching chamber as shown in FIG. 1 or 2 is inserted on the fixed-contact side, and a pressure-resistant inlay is inserted within a metallic cover in one section on the switching-contact side.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A vacuum switching chamber for a medium-voltage switchgear assembly having one or more ceramic cylinder tube sections which are closed both on the fixed-contact side and on the switching-contact side by metallic covers, wherein at least one of the covers, arranged on the inside and/or outside, is provided with an inlay, which increases the resulting wall thickness, or overlay, which inlay or overlay rests at least partially cohesively in the cover or on the outside.

2. The vacuum switching chamber according to claim 1, wherein the inlay is dimensioned and introduced such that it leaves a small gap from the bearing rim of the ceramic such that an integral collar formation of a central screen can be accommodated therebetween in the inner contact region during fitting.

3. The vacuum switching chamber according to claim 1, wherein the inlays or the cover is fitted on the outside and reach or reaches up to the inner front face of the covers such that the vacuum switching chamber is also capable of transmitting forces in the longitudinal direction.

4. The vacuum switching chamber according to claim 1, wherein the inlay or overlay together with the cover in total approximately correspond to the wall thickness of the ceramic.

5. The vacuum switching chamber according to claim 1, wherein the inlays or an outer ring are designed such that they remain restricted to regions with a reduced wall thickness only in the region of the ceramic/metal joint.

6. The vacuum switching chamber according to claim 1, wherein both cover sides of the vacuum switching chamber is provided with in each case one inlay, a cover arranged on the outside or an outer ring.

7. The vacuum switching chamber according to claim 1, wherein only one cover side is provided with an inlay, a cover or ring, while the other side is provided with a bowl-like shaped-out portion of the ceramic body which replaces the cover.

8. The vacuum switching chamber according to claim 1, in which a bowl-shaped ceramic insulator is used to increase the resistance to pressure at least on one side, wherein said ceramic insulator reaches completely up to or at least close to the two feed lines of the VC.

9. The vacuum switching chamber according to claim 8, in which a bowl-shaped ceramic is used only on one side, and a cover closes the VC on the other side, wherein a reinforcing inlay is used according to claim 1 in order to achieve a high resistance to pressure.

10. The vacuum switching chamber according to claim 2, wherein the inlays or the cover is fitted on the outside and reach or reaches up to the inner front face of the covers such that the vacuum switching chamber is also capable of transmitting forces in the longitudinal direction.

11. The vacuum switching chamber according to claim 2, wherein the inlay or overlay together with the cover in total approximately correspond to the wall thickness of the ceramic.

12. The vacuum switching chamber according to claim 4, wherein the inlays or an outer ring are designed such that they remain restricted to regions with a reduced wall thickness only in the region of the ceramic/metal joint.

13. The vacuum switching chamber according to claim 5, wherein both cover sides of the vacuum switching chamber is provided with in each case one inlay, a cover arranged on the outside or an outer ring.

14. The vacuum switching chamber according to claim 5, wherein only one cover side is provided with an inlay, a cover or ring, while the other side is provided with a bowl-like shaped-out portion of the ceramic body which replaces the cover.

15. A method of arranging a vacuum switching chamber for a medium-voltage switchgear assembly having one or more ceramic cylinder tube sections with a fixed-contact side and a switching-contact side, the method comprising:
closing the ceramic cylinder tube sections on the fixed-contact side and on the switching-contact side by metallic covers;
providing at least one of the covers with an inlay which increases the resulting wall thickness; and
resting an outer cover, an outer ring or the inlay at least partially cohesively in the cover or on a cover on the outside.

16. The method according to claim 15, wherein the arrangement resists to withstand external pressure.
